(19) United States
(12) Patent Application Publication
(10) Pub. No.: US 2007/0058368 A1
(43) Pub. Date: Mar. 15, 2007

(54) EFFICIENT HIGH BRIGHTNESS LED SYSTEM THAT GENERATES RADIOMETRIC LIGHT ENERGY CAPABLE OF CONTROLLING GROWTH OF PLANTS FROM SEED TO FULL MATURITY

(76) Inventors: Adam Mark Partee, Dublin, OH (US); Zachary John Griffin, Dublin, OH (US)

Correspondence Address: ADAM PARTEE, 3094 ESSINGTON DR., DUBLIN, OH, 43017, US

(21) Appl. No.: 11/162,423

(22) Filed: Sep. 9, 2005

(51) Int. Cl. F21V 9/00

(52) U.S. Cl. 362/231; 362/294; 362/373; 362/805; 362/800

(57) ABSTRACT

According to one or more aspects of the present invention, a unit is disclosed that provides artificial light to promote plant growth. The unit utilizes red and blue light emitting diodes (LEDs) to emit wavelengths of light that are more favorable to plant growth. In particular, blue LEDs are interspersed with red LED's to broadcast a desired range of light. Although the LEDs operate at lower temperatures than conventional artificial light sources and thus allow the unit to be placed closer to plants for more efficient growth, the unit includes a heat sink to disperse even more heat. Separate switches are included to control the red and blue LEDs to allow controlled exposure to different light sources to facilitate desired plant growth.

### DESCRIPTION

The present invention relates to the field of plant growth, and more particularly to growing plants with LED fixtures used as the primary source of light energy.

### BACKGROUND OF THE INVENTION

The use of Light Emitting Diodes (LED) as a source of energy for plant growth has been studied and attempted with little to no success. For example, the use of low power diodes does not supply a sufficient level of mixed light necessary for plants to carry out photosynthetic processes.

U.S. Pat. No. 6,688,759; U.S. Pat. No. 6,602,275; U.S. Pat. No. 6,474,838; U.S. Pat. No. 5,278,432; and U.S. Pat. No. 5,012,609 are examples of conventional lighting techniques that attempt to facilitate plant growth. However, the systems, devices, techniques, etc. disclosed in these patents are not capable of producing the level of light energy necessary to grow light intensive plants completely through the life cycle from seed until full maturity. Additionally, a large number of small diodes are implemented in at least some of these teachings which dramatically increases the cost of production per unit.

Consequently, a cost effective technique that implements light emitting diodes to facilitate plant growth would be desirable.

The following presents a simplified summary of the invention in order to provide a basic understanding of some aspects of the invention. This summary is not an extensive overview of the invention. It is intended neither to identify key or critical elements of the invention nor to delineate the scope of the invention. Rather, its primary purpose is merely to present one or more concepts of the invention in a simplified form as a prelude to the more detailed description that is presented later.

Currently, the majority of plants grown using artificial light are nourished with light emitted from either high pressure sodium (HPS) bulbs, metal halide (MH) bulbs or fluorescent bulbs. Unfortunately, these sources are inefficient with regard to the light energy they provide to promote plant growth, at least, in that most of the light energy they produce is useless or unnecessary for plants to carry out photosynthesis. Moreover, some of the light that these sources produce can, in some cases, be damaging to plants.

Utilizing light emitting diodes (LEDs) according to one or more aspects of the present invention, however, facilitates safe and healthy plant growth. This is due primarily to the specific wavelengths of light output by the LEDs. Utilizing LEDs according to one or more aspects of the present invention also allows plants that require a large amount of light energy to be grown, which was not heretofore achievable.

Research in LEDs and solid state lighting (SSL) has led to the development of LEDs that are capable of producing substantially larger levels of light output. The increase in efficiency is made possible by drawing heat away from the junction point of the LED and allowing it to safely operate at higher currents. Nevertheless, as is discussed below, a heat sink is included in an exemplary grow light system that implements high brightness LEDs (HBLEDs) in accordance with one or more aspects of the present invention. The heat sink enhances efficiencies by allowing the LEDs to be placed closer to the plants, and also mitigates negative linear effects on overall light output intensities.

More particularly, one or more heat sinks and fans are implemented in the LED grow light design according to one or more aspects of the present invention to drastically reduce the junction temperature of the LEDs thereby providing for desired yet safe performance. Heat which radiates from the LEDs is transferred from the diode through a heat sink and released to ambient moving air. This design allows for low operating temperatures which in turn increases light output, and prolongs the life of the LEDs.

It can be appreciated that the level of absorption of light energy during the photosynthetic process fluctuates depending on wavelength intensities. Plants efficiently absorb light energy between the wavelengths of between about 610-700 nm and about 400-520 nm. Plants exposed to light intensities in these regions show an extreme rise in the production of Chlorophyll A and B. The presence of blue light in the about 400-520 nm range triggers the processes of morphogenesis which causes the plant to morph through adolescents. In contrast, red light at about 610-700 nm provides energy for the plant and encourages reproductive processes to commence.

In an exemplary LED grow light system according to one or more aspects of the present invention, 11 high brightness LED's are utilized (e.g., 8 red HBLEDs with a peak at about 638 nanometers and 3 blue HBLEDs with a peak at about 450 nanometers). The layout of red and blue LEDs allows for desired (e.g., even) distribution of light across the plants being exposed so as to facilitate photosynthesis. In one example, this is achieved by using elliptical optics on the red LEDs, which disperses the light out of the LED in a pattern of about 12 degrees by about 50 degrees. This places a large amount red light energy in a desired pattern. The blue LEDs are fitted with about 50 degree optics which allow for a larger and more even distribution of blue over a larger canopy area. This lower level of light fulfills the about 400-520 nm range requirements of plants to carry out photosynthesis A.

It will be appreciated that a system for facilitating plant growth according to one or more aspects of the present invention allows for the adequate mixing of light energy necessary for plants to carry out their entire life cycle. It also allows for manipulation and control of the metamorphic and reproductive processes of the plants while lowering energy consumption. This is made possible in one example through the implementation of two switches which allow a user to turn on and off separate blue and red light series. This feature influences the production of Chlorophyll A and B in a plant system and therefore controls the metamorphic and reproductive processes in the plant.

To the accomplishment of the foregoing and related ends, the following description and annexed drawings set forth in detail certain illustrative aspects and implementations of the invention. These are indicative of but a few of the various ways in which one or more aspects of the present invention may be employed. Other aspects, advantages and novel features of the invention will become apparent from the following detailed description of the invention when considered in conjunction with the annexed drawings.

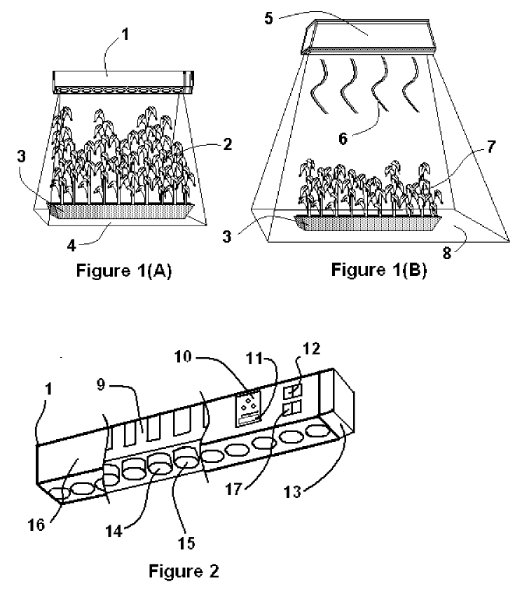

FIG. 1A illustrates the use of an artificial lighting apparatus according to one or more aspects of the present invention to provide the energy necessary for plants to carry out photosynthesis.

FIG. 1B illustrates a conventional mechanism for providing artificial light to facilitate plant growth.

FIG. 2 illustrates mechanical and electrical aspects of an artificial lighting system according to one or more aspects of the present invention.

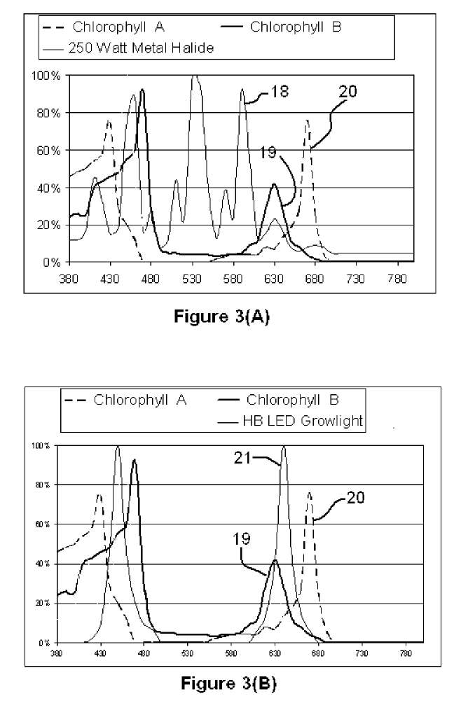

FIGS. 3 (A-B) are graphs that depict level(s) of light absorption by plants with respect to different light wavelengths.

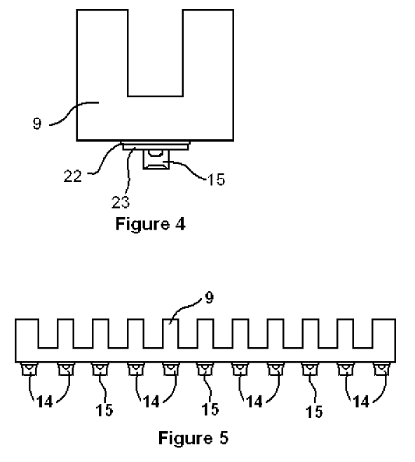

FIG. 4 illustrates an exemplary mechanism that dissipates heat away from the LED to the ambient air according to one or more aspects of the present invention.

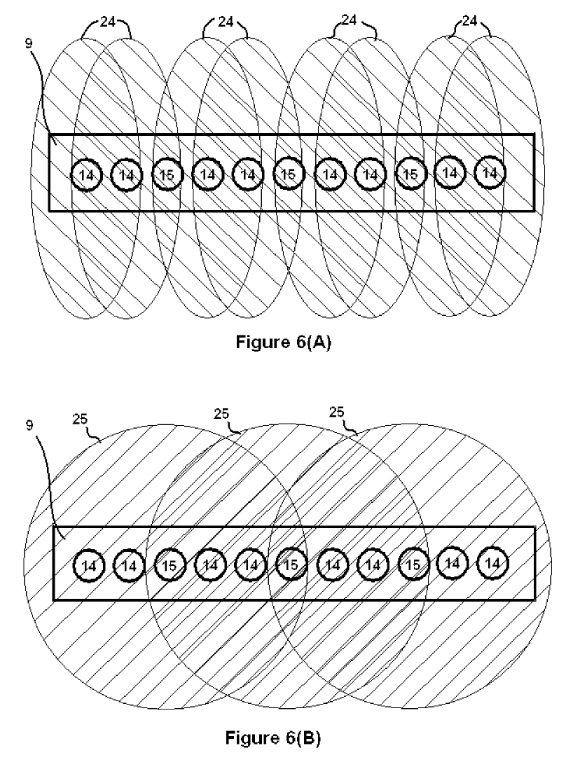

FIG. 5 illustrates an exemplary high brightness LED (HBLED) layout on a heat sink with respect to LED color and optics according to one or more aspects of the present invention.

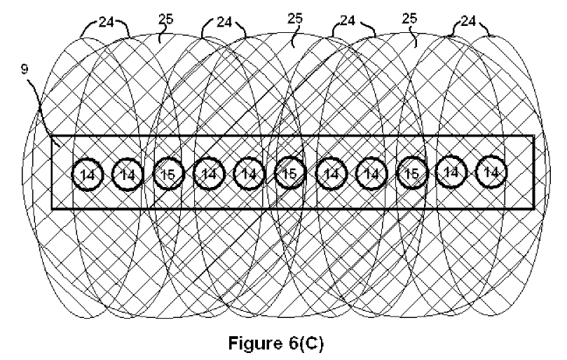

FIGS. 6A-6C illustrate an exemplary light spread produced according to one or more aspects of the present invention under different operating conditions.

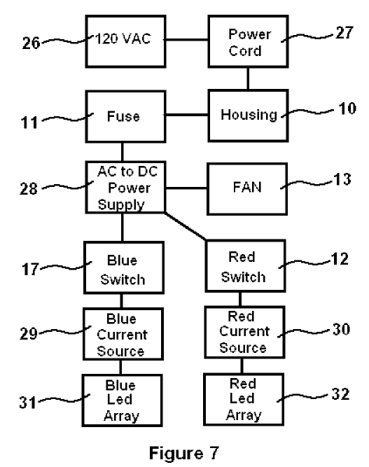

FIG. 7 is a block diagram illustrating exemplary electrical characteristics of one or more aspects of the present invention.

One or more aspects of the present invention are described with reference to the drawings, wherein like reference numerals are generally utilized to refer to like elements throughout, and wherein the various structures are not necessarily drawn to scale. It will be appreciated that where like acts, events, elements, layers, structures, etc. are reproduced, subsequent (redundant) discussions of the same may be omitted for the sake of brevity. In the following description, for purposes of explanation, numerous specific details are set forth in order to provide a thorough understanding of one or more aspects of the present invention. It may be evident, however, to one of ordinary skill in the art that one or more aspects of the present invention may be practiced with a lesser degree of these specific details. In other instances, known structures are shown in diagrammatic form in order to facilitate describing one or more aspects of the present invention.

Referring to FIG. 1A, a diagram is presented that illustrates an exemplary system or apparatus 1 for providing artificial light to plants to facilitate plant growth according to one or more aspects of the present invention. In the illustrated example, the apparatus 1 is placed over a set of plants 2 which are placed in potting material 3. The device 1 is configured so that the area of light 4 output thereby is directed over the plants 2 so as to mitigate inefficiencies and wasting light energy.

FIG. 1B illustrates a conventional arrangement for providing artificial light to facilitate plant growth, namely where high pressure sodium (HPS) bulbs and/or metal halide (MH) bulbs are utilized. The traditional grow system 5 is highly inefficient due to the large amount of energy that is released as heat 6. It can thus be appreciated that, placing the traditional grow light 5 close to the plant 7 canopy can be detrimental to the plants' health due to the extreme temperatures 6 released by the high power light 5. Accordingly, in order to achieve safe growing temperatures the light must be raised away from the canopy or tops of the plants. This is undesirable, however, because, among other things, raising of the light creates a larger less efficient coverage area 8, with lower light intensity. As such, plants grown under light emitted from such a conventional apparatus 5 (which is at a lower than desired intensity) are less healthy than plants grown according to one or more aspects of the present invention. It will be appreciated that the conventional unit 5 may be about ½ to about 3 feet above the plants, whereas a unit 1 as described herein may only be between about an inch to about 10 inches above the plants.

FIG. 2 represents a housing and other aspects of a design of an exemplary LED grow light system 1 according to one or more aspects of the present invention. A body of the grow light system 1 comprises a heat sink 9 (e.g., metal, ceramic, clay, etc.) that dissipates heat generated by a plurality of LEDs 14, 15. Covering the heat sink 9 is a protective housing 16 that facilitates air flow to help rid excess heat. Air can be forced through the housing 16 and over the heat sink 9, for example, via a small fan 13 with hypro bearings. The unit can be powered by 120 VAC, for example, through a power input 10 which can be protected against overload via a fuse 11. A plurality of red 14 and blue 15 leds are included in the illustrated example and can be controlled by switches mounted on the side of the housing. In the illustrated example, two switches 12 and 17 are included, and can be toggled to control respective arrays of red and blue LEDs, for example. By way of futher example, the unit 1 can have a length of between about 10 inches and about 60 inches, a height of between about 2 inches and about 10 inches, a width of between about 2 inches and about 12 inches and/or a weight of between about 1 pound and about 12 pounds.

The graphs presented in FIGS. 3A and 3B illustrate respective levels of plant light absorption (0-100%) (y axis) with respect to corresponding wavelengths (380-800 nm) (x axis). A healthy plant generally makes use of or absorbs two different levels of light energy, namely between the wavelengths of about 610-700 nm and about 400-520 nm. In each of these ranges the production of Chlorophyll A 20 and Chlorophyll B 19 can be said to “spike”. Exposing plants to light having wavelengths of between about 400-520 nms triggers the processes of morphogenesis which causes plants to morph through adolescence, whereas exposing plants to light having wavelengths of between about 610-700 nms encourages reproductive processes to commence.

Unfortunately, as can be seen in FIG. 3A, the majority of light 18 produced by conventional (e.g., 250 watt metal halide) systems falls within the 500 to 600 nm range. The absorption of light by plants in this region is relatively low, fluctuating between about 0 and 8%. Accordingly, FIG. 3A demonstrates that significant inefficiencies exist with conventional designs in that at least about 92% of the light energy produced by those systems (e.g., in the 500 to 600 nm range) is not absorbed by plants.

By comparison, FIG. 3B illustrates efficiencies associated with providing artificial light to facilitate plant growth in accordance with one or more aspects of the present invention. In particular, the light 21 produced with high brightness LEDs (HBLEDs) according to one or more aspects of the present invention “spikes” at wavelengths of between about 400-500 nm and about 600-700 nm. In each of these regions there is much greater overlap with spikes in the production of Chlorophyll A and Chlorophyll B as compared to the conventional case illustrated in FIG. 3B. Accordingly, utilizing both red LED's (which output light at wavelengths of between about 600-700 nm) and blue LED's (which output light at wavelengths of between about 400-520 nm) in accordance with one or more aspects of the present invention facilitates efficient light energy utilization and plant growth.

FIG. 4 illustrates an exemplary placement of a HBLED and its color corresponding collimator optic 15 on a heat sink 9 according to one or more aspects of the present invention. The LED and optic 15 are attached to an (aluminum) printed circuit board (PCB) 23 in the illustrated example, which is then secured to the heat sink 9 via a thermally conductive adhesive 22, for example. This system allows for efficient transfer of the (minimal) heat that LEDs produce from the junction point to the heat sink 9. This allows for greater LED light intensities and a prolonged LED operating life.

FIG. 5 illustrates an exemplary layout of the LEDs on a heat sink 9 according to one or more aspects of the present invention. In the illustrated example, there are a total of 8 red LEDs 14 that are placed in pairs between 3 individual blue LEDs 15. This exemplary physical layout of LEDs along with associated optical characteristics allows for an even distribution of light from the unit to the plants.

FIGS. 6A-C illustrate different exemplary light coverage areas of separate LEDs according to one or more aspects of the present invention with respect to different optical characteristics and operating conditions. For example, FIG. A represents light output of red HBLEDs with 12×50 degree optics 14. The light spread of each individual red HBLED is represented by a shaded oval 24. The over-lapping of the ovals allows for higher levels of red light output from the LEDs to the plant canopy. The overall length of the unit that 9 allows for multiple plants to receive substantially the same level of light output.

FIG. 6B illustrates light output produced by blue LEDs which are equipped with 50 degree optics 15. The optical spread of the blue LEDs is represented by a shaded circle 25. Blue light is necessary for plants to carry out the growth process; however it is not needed in abundance. The light spread of the blue HBLEDs with optics 25 satisfies the level of blue light that is necessary for healthy plant growth through its entire life cycle.

FIG. 6C illustrates the light spread of both the red 14 and blue 15 HBLEDs. The overlapping of light spreads created by different optics allows for even distribution of both red 24 and blue 25 light energy.

FIG. 7 illustrates a block diagram of some of the electrical characteristics of an HBLED system according to one or more aspects of the present invention. The system operatively coupled to a power source, such as by being plugged into a 120 VAC 26 source via a power cord, for example. In the illustrated example, the power is carried through the cord 27 to a housing 10 and through a fuse 11 to a power supply 28, where the power is switched over to a lower manageable direct current (DC current). This DC current can then be directed to a fan 13, switches 12 that control red LEDs and/or switches 17 that control blue LEDs. The switches 12, 17 can, for example regulate current at 1000 ma 30 for a series of red LEDs 32 and/or at 800 ma 29 for a series of blue LEDs 31, for example. Such current regulators 29, 30 allow for safe operating currents with respect to HBLEDs, for example.

Although one or more aspects of the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature or aspect of the invention may have been disclosed with respect to only one of several implementations, such feature or aspect may be combined with one or more other features or aspects of the other implementations as may be desired and/or advantageous for any given or particular application. Furthermore, to the extent that the terms “includes”, “having”, “has”, “with”, or variants thereof are used in either the detailed description or the claims, such terms are intended to be inclusive in a manner similar to the term “comprising.” Additionally, “exemplary” is merely meant as an example, rather than the best.

What is claimed is:

1. A unit configured to provide artificial light to facilitate plant growth, comprising:
one or more red light emitting diodes (LEDs) which output light at wavelengths of between about 600-700 nm;
one or more blue LEDs which output light at wavelengths of between about 400-520 nm; and a power supply operatively coupled to the red and blue LEDs to supply power to the red and blue LED's, where the LEDs are located between about an inch to about 10 inches above plants to provide light thereto.

2. The unit of claim 1, further comprising:
a heat sink operatively coupled to one or more of the LEDs.

3. The unit of claim 2, wherein at least one of the LEDs is outfitted with an optic to facilitate desired light dispersion.

4. The unit if claim 3, wherein at least one of,
at least one of the red LEDs is outfitted with a 12×50 degree optic, and
at least one of the blue LEDs is outfitted with a 50 degree optic.

5. The unit of claim 3, wherein the heat sink is covered by a housing that facilitates air flow to cool the unit.

6. The unit if claim 5, further comprising:
a fan to facilitate air flow to cool the unit.

7. The unit of claim 6, wherein the fan comprises hypro bearings.

8. The unit of claim 6, wherein the fan is powered by a 120 volt supply.

9. The unit of claim 3, further comprising at least one of,
a switch to turn off/on one or more red LEDs, and
a switch to turn off/on one or more blue LEDs.

10. The unit of claim 9, wherein at least one of,
multiple red LED's are coupled in an array, and
multiple blue LED's are coupled in an array.

11. The unit of claim 3, wherein at least one of the LEDs is operatively coupled the heat sink via a printed circuit board.

12. The unit of claim 11, wherein the printed circuit board is operatively coupled to the heat sink via a thermally conductive adhesive.

13. The unit of claim 3, wherein there are 8 red LEDs that are placed in pairs between 3 blue LEDs.

14. The unit of claim 3, wherein at least one of,
the red LEDs are powered by a 1000 ma current, and
the blue LEDs are powered by an 800 ma current.

15. The unit of claim 3, wherein multiple red LEDs are coupled in an array and multiple blue LEDs are coupled in an array, and where at least one of,
the red LEDs are powered by a 1000 ma current,
the blue LEDs are powered by an 800 ma current,
a switch allows the red LEDs to be turned on/off, and
a switch allows the blue LEDs to be turned on/off.

16. The unit of claim 3, further comprising a fuse to protect electrical components therein.

17. The unit of claim 3, wherein at least one of,
the unit has a length of between about 10 inches and about 60 inches,
a height of between about 2 inches and about 10 inches,
a width of between about 2 inches and about 12 inches, and
a weight of between about 1 pound and about 12 pounds.
